(19) United States
(12) Patent Application Publication
(10) Pub. No.: US 2024/0013965 A1
(43) Pub. Date: Jan. 11, 2024

(54) MAGNETIC CORE

(71) Applicant: Hamilton Sundstrand Corporation, Charlotte, NC (US)

(72) Inventors: Ponggorn KULSANGCHAROEN, Solihull (GB); Rodrigo FERNANDEZ-MATTOS, Solihull (GB); Kedar PITHWA, Hemel Hampstead (GB)

(21) Appl. No.: 18/348,432

(22) Filed: Jul. 7, 2023

(30) Foreign Application Priority Data
Jul. 7, 2022 (EP) 22275090.3

(51) Int. Cl. H01F 27/245; H01F 30/06; H01F 3/14; H01F 27/28; H01F 27/26; H01F 41/02

(52) U.S. Cl. CPC H01F 27/245; H01F 30/06; H01F 3/14; H01F 27/2823; H01F 27/263; H01F 41/0233

(57) ABSTRACT

A magnetic core section of a transformer or an inductor, includes a substantially rectangular core section body having opposing sides joined by opposing ends, and further comprising interlocking features provided at each of the ends, shaped to interlock with interlocking features of complementary core sections.

### CROSS REFERENCE TO RELATED APPLICATION

This application claims priority to European Patent Application No. 22275090.3 filed Jul. 7, 2022, the entire contents of which is incorporated herein by reference.

### TECHNICAL FIELD

The present disclosure relates to a magnetic core design for transformers or inductors.

### BACKGROUND

Transformers are used in many electrical systems to transform voltage or current at one level to voltage and/or current at a different level. A transformer consists of one or more windings or coils of conductive material e.g. electrically insulated copper, wound around a ferrous or magnetic core such that current flow through one winding or part of a winding will induce current flow through another winding or part of a winding. Many systems e.g. power converters used in applications such as aircraft, convert AC power to DC power to drive DC loads. Three-phase transformers made from very thin laminated sheets of silicon steel or amorphous iron material are commonly used in medium to high power AC/DC power conversion systems. These transformers are suitable for operating frequencies of 200 Hz to 2 kHz because they have low core loss and very high flux saturation characteristics. To reduce harmonics in such systems, it has become common to use autotransformers which only have a single winding acting as both the primary and the secondary winding of the system. Auto-transformers are used, for example, in power conversion systems on aircraft to provide power to the various electric loads.

Transformer and inductor cores may have different shapes. Common shapes are E, I, C or U. E and I shaped cores may be combined as EE or EI shaped cores. Two C or U shaped cores, or a C or U and an I shaped core may be combined to an O shaped or oval core. The windings are generally wound onto bobbins first before being assembled together with the cores—onto the core legs. For combined EE or EI cores, the core parts are then typically held together by metal straps, with the bobbins provided around the adjoining legs.

A disadvantage of these conventional methods and designs is that the bobbins around which the windings have to be wound to keep then around the adjoining core parts that form the core legs take up space in the transformer that could otherwise be used for more windings. Further, the bobbins limit effective heat transfer between the windings and the cores. The manufacturing and assembly process of these conventional designs requires the three steps of machining the transformer coil, winding the conductors onto the bobbin and assembling the core parts and the bobbins. The parts then have to be secured together by the metal strap or other mechanical fastening means which adds a further assembly step and also adds to the overall weight of the core.

Whilst these traditional designs work well as transformers in most cases, it would be desirable to provide a core design that overcomes some or all of these disadvantages.

### SUMMARY

According to the present disclosure, there is provided a magnetic core section comprising a substantially rectangular core section body having opposing sides joined by opposing ends, and further comprising interlocking features provided at each of the ends, shaped to interlock with interlocking features of complementary core sections.

Also provided is a magnetic core, a method of manufacturing a magnetic core section and a method of assembling a magnetic core.

### BRIEF DESCRIPTION

Examples will now be described with reference to the drawings. It should be noted that these are examples only and that variations are possible within the scope of the claims. The description will focus on transformer cores, but the principles apply equally to inductor cores.

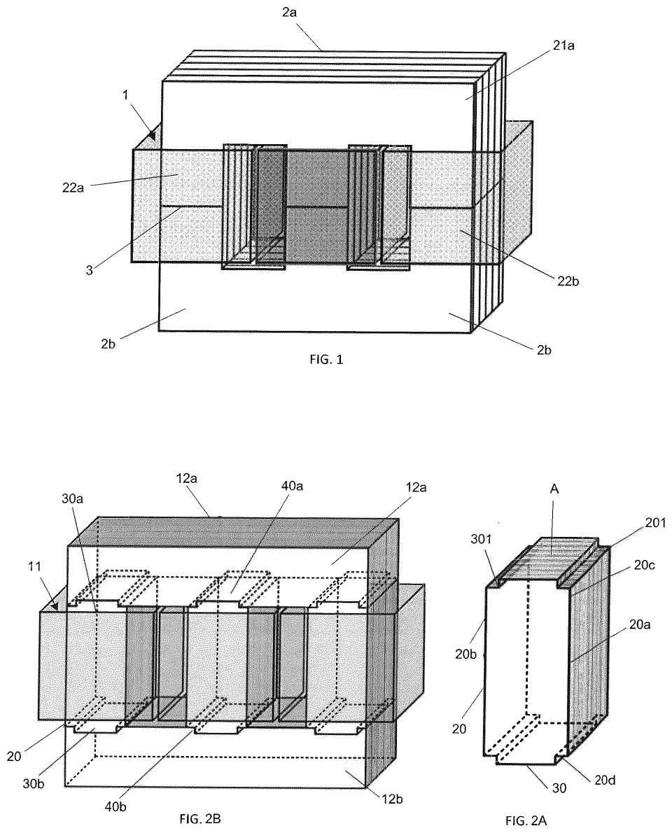

FIG. 1 shows an examples of a conventional EE core design for the purposes of background.

FIG. 2A shows an example of a core section in accordance with the disclosure.

FIG. 2B shows the core section of FIG. 2A fitted with complementary core sections to form an EE core design.

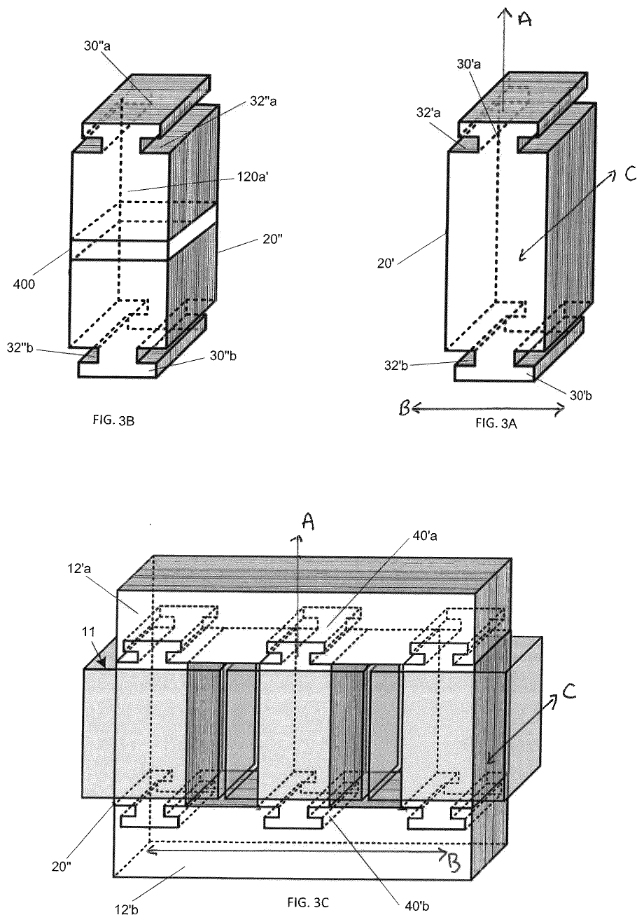

FIG. 3A shows an example of an alternative core section in accordance with the disclosure.

FIG. 3B shows an example of an alternative core section in accordance with the disclosure.

FIG. 3C shows the core section of FIG. 3A or 3B fitted with complementary core sections to form an EE core design.

### DETAILED DESCRIPTION

FIG. 1 shows a typical EE core design. The core comprises two complementary E-shaped core sections 2a, 2b each having a spine 21a, 21b from which three legs 22 a, 22b extend. To form the EE core, the two E-shapes are assembled such that their respective legs 22a, 22b align and abut. Each core section 2a, 2b is made of a stack of thin laminated sheets locked, glued, welded etc. together as is known in the art. The transformer windings 1 are formed by winding conductive wires e.g. electrically insulated copper wires wound onto a bobbin. This is not shown in detail as it is well known in the art. Each winding 1 (i.e. conductor wound onto a bobbin) is fitted around an abutting pair of legs of the two cores. To assemble, the winding would typically be fitted over one of the legs of one of the core sections and then the other core section would be assembled such that its corresponding legs fits through the bobbin and abuts the leg of the first core section, such that the winding is provided around the join 3 between the two abutting legs as seen in FIG. 1. The hold the assembly together, clamps or straps would be fastened around the core sections (not shown here, but well-known in the art). Similar principles apply to transformer cores made by combining other core section shapes e.g. I, C or U shapes.

The present disclosure provides a transformer core section onto which conductors may be fitted already wound onto a bobbin, as is conventional, but also provides the possibility of directly winding the conductive wire onto the core section without the need for a bobbin. In some cases, extra electrical insulation, but highly thermally conductive material, such as thin sheets or films can also be put on the core prior to the winding process. The core section is in the form of a substantially rectangular block having sides 20a, 20b joined by ends 20c, 20d. The ends 20c. 20d are provided with interlocking features that can interlock with complementary features in other core parts to form the desired transformer core shape. The core section 20 may be fabricated in a manner similar to conventional core sections in that it comprises several laminated sheets 201 stacked together and secured by interlocking, gluing, welding etc. In other examples, however, the core section may be fabricated as a solid block. The core section 20 can then be prepared by providing the winding 11 around it (either on a bobbin or by directly winding the conductor onto the core section). The wound core section is then fitted to complementary core sections 12a, 12b by means of the matching interlocking features 30a, 30b at the ends of the core section which engage and interlock with matching features 40a, 40b of the complementary core sections 12a, 12b.

Whilst the examples shown here combine the core section 20 with two complementary sections 12a, 12b to form an EE core design, the same concept can be used to form other shapes e.g. CC, UU, CI, UI, EI by selecting appropriate complementary sections. Designs with other numbers of legs are also possible.

The interlocking features 30a, 30b are shaped to interlock—i.e. to fit into and secure to interlocking shapes 40a, 40b on the complementary core sections. One example is shown in FIGS. 2A and 2B where the interlocking feature on each end of the core section 20 is formed as a tooth defining a notch 301 on either side. This can then lock into a correspondingly shaped recesses 40a, 40b formed in the complementary core section. The sides of the tooth may be tapered outwards in the direction away from the end of the core section to secure the core sections against relative axial (direction A) movement when the core section 20 is slotted into place between the complementary core sections and its teeth 30a, 30b are slotted into the recesses 40a, 40b. Even straight edges, however, will provide some degree of interlocking between the core sections. In the example shown in FIG. 2B, three such core sections 20 are assembled between two substantially I shaped complementary sections 12a, 12b forming an EE shaped core where the core section 20 of this disclosure effective replaces the abutting legs 22a, 22b of the conventional arrangement of FIG. 1. Because it is not essential to provide the windings on bobbins before assembly, the core can be formed with sufficient gaps between the core sections to prevent flux saturation due to any imbalances and DC flux. In preferred assemblies the gaps may be large enough to be within the tolerance capability of standard transformer machining tools (e.g. 50 μm).

In an alternative example, as shown in FIGS. 3A and 3B, the interlocking features may be in the form of a T-shaped protrusion 30′a, 30′b or 30″a, 30″b extending from the end of the core section 20′ or 20″, this defining detents 32′a, 32′b; 32″a, 32″b between the bar of the T and the end of the core section. The complementary sections 12′a, 12′b would then have respecting C-shaped interlocking features 40′a, 40′b to lock around the end of the T and secure in the detents. A benefit of this embodiment compared to that of FIGS. 2A and 2B is that the complementary T-shaped and C-shaped interlocking features lock the core section and the complementary section together in both direction A (up and down when viewing the drawings) and direction B (side to side when viewing the drawings). The sections can move relative to each other in direction C (into and out of the page) for assembly—sliding the T-shaped features into the C-shaped features. If desired, this movement can be blocked after assembly by some housing component e.g. a lightweight cap or some form of clamp or the like. Such a cap or clamp or the like can add to the size/weight/volume of the design but, if designed well, can provide thermal conduction enhancement to the transformer/inductor depending on operating conditions or environment.

In the example shown in FIG. 3B, an air gap 400 may be formed between two halves 120a′, 120b′. An air gap 400 may be provided in core sections having interlocking features other than the T-shaped protrusions shown in FIG. 3B. This feature allows the air gap to be controlled to contribute to preventing magnetic flux saturation. Without this air gap, the transformer can only rely on the tolerance between parts 20′ and 12′a and parts 20′ and 12′b to stop the flux saturation, which is the main constraint in manufacturing the transformer core design. Other interlocking features may also be envisaged. Whilst the examples show the core section having interlocking features extending from the ends which interlock with recessed interlocking features of the complementary core sections, it is feasible that the interlocking features of the core section are recessed with respect to the ends and interlock with protruding interlocking features of the complementary core sections.

Fewer steps are required to manufacture and assemble the core using the core section 20, 20′, 20″ of this disclosure, particularly when the windings are provided directly onto the core section. The core section and winding 11 are preassembled and are then slotted in to interlock with the complementary core sections and the interlocking holds the entire assembly together without the need for mechanical straps, full housings etc. This simplifies manufacture and assembly and also reduces overall weight. Direct winding onto the core section also improves heat transfer between the winding and the core and reduces the cooling requirements, and may also reduce transformer losses as any fringe flux effect occurring at air gaps between adjacent cores is moved away from the windings.

The core section can be easily manufactured by stamping the required shape from sheet metal. Also, EE shaped cores, for example, can be formed from only I shaped sections which simplifies manufacture.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is limited to the particular embodiment disclosed as the best mode contemplated for carrying out this present disclosure, but that the present disclosure will include all embodiments falling within the scope of the claims.

1. A magnetic core section comprising:
a substantially rectangular core section body, the body including:
opposing sides joined by opposing ends; and
interlocking features provided at each of the ends, shaped to interlock with interlocking features of complementary core sections.

2. The magnetic core section of claim 1, wherein the core section body is formed of a plurality of laminated sheets stacked together.

3. The magnetic section of claim 1, wherein the interlocking features are in the form of teeth extending from the ends.

4. The magnetic core section of claim 3, wherein the teeth have tapered sides.

5. The magnetic core section of claim 1, wherein the interlocking features are in the form of T-shaped protrusions extending from the ends.

6. The magnetic core section of claim 1, wherein the core section body comprises two parts separated by an air gap.

7. The magnetic core section of claim 1, further comprising a winding of conductive material wound around the body.

8. The magnetic core section of claim 1, being a core section of a transformer or an inductor.

9. A magnetic core comprising:
one or more magnetic core sections as claimed in claim 1; and
two complementary core sections, the one or more magnetic core sections fitted between and interlocking with the complementary core sections by interlocking engagement of the interlocking features at the ends of the core section with the interlocking features of the complementary core sections.

10. The magnetic core of claim 9, comprising two magnetic core sections as claimed in claim 1, and wherein the complementary core sections each have two interlocking features.

11. The magnetic core of claim 9, comprising three magnetic core sections as claimed in claim 1 and wherein the complementary core sections each have three interlocking features to form an EE core.

12. A method of manufacturing a magnetic core section as claimed in claim 1, the method comprising:
stamping a shape of the body and the interlocking features from sheet metal to form a shaped laminate; and
stacking a plurality of the shaped laminates to form the core section body.

13. The method of claim 11, further comprising:
winding a conductive wire around the core section body to form a transformer or inductor winding.

14. A method of assembling a transformer core comprising:
manufacturing one or more magnetic core sections according to the method of claim 12;
providing two complementary core sections; and
interlocking the one or more magnetic sections between the two complementary core sections by engaging corresponding interlocking features.
